(19) United States
(12) Patent Application Publication
(10) Pub. No.: US 2017/0183971 A1
(43) Pub. Date: Jun. 29, 2017

(54) TIP SHROUDED TURBINE ROTOR BLADES

(71) Applicant: General Electric Company, Schenectady, NY (US)

(72) Inventors: Michael McDufford, Greenville, SC (US); Jeffrey Clarence Jones, Simpsonville, SC (US)

(73) Assignee: General Electric Company

(21) Appl. No.: 14/979,788

(22) Filed: Dec. 28, 2015

(51) Int. Cl. F01D 5/22; F01D 11/00

(52) U.S. Cl. CPC F01D 5/225; F01D 11/006; F05D 2220/32; F05D 2230/10; F05D 2240/307

(57) ABSTRACT

A rotor blade for a gas turbine that includes an airfoil and a tip shroud. The tip shroud may have a seal rail that projects radially from an outboard surface and extends circumferentially. The tip shroud may further include: a rotationally leading circumferential face; a rotationally trailing circumferential face; and an outboard face of the seal rail. The tip shroud may be circumferentially divided into three parallel reference zones: a rotationally leading edge zone, a rotationally trailing edge zone and, formed between and separating those, a middle zone. The seal rail may include a hollow cavity wholly contained within at least one of the rotationally leading edge zone and the rotationally trailing edge zone. The cavity may include a mouth formed through at least one of the rotationally leading circumferential face, the rotationally trailing circumferential face, and the outboard face of the seal rail.

### BACKGROUND OF THE INVENTION

The present application relates generally to apparatus, methods and/or systems concerning the design, manufacture, and use of rotor blades in combustion or gas turbine engines. More specifically, but not by way of limitation, the present application relates to apparatus and assemblies pertaining to turbine rotor blades having tip shrouds.

In combustion or gas turbine engines (hereinafter “gas turbines”), it is well known that air pressurized in a compressor is used to combust fuel in a combustor to generate a flow of hot combustion gases, whereupon the gases flow downstream through one or more turbines so that energy can be extracted therefrom. In accordance with such engines, generally, rows of circumferentially spaced rotor blades extend radially outwardly from a supporting rotor disc. Each rotor blade typically includes a dovetail that permits assembly and disassembly of the blade in a corresponding dovetail slot in the rotor disc, as well as an airfoil that extends radially outwardly from the dovetail and interacts with the flow of the working fluid through the engine. The airfoil has a concave pressure side and convex suction side extending axially between corresponding leading and trailing edges, and radially between a root and a tip. It will be understood that the blade tip is spaced closely to a radially outer stationary surface for minimizing leakage therebetween of the combustion gases flowing downstream between the turbine blades.

Shrouds at the tip of the airfoil or “tip shrouds” often are implemented on aftward stages or rotor blades to provide a point of contact at the tip, manage bucket vibration frequencies, enable a damping source, and to reduce the over-tip leakage of the working fluid. Given the length of the rotor blades in the aftward stages, the damping function of the tip shrouds provides a significant benefit to durability. However, taking full advantage of the benefits is difficult considering the weight that the tip shroud adds to the assembly and the other design criteria, which include enduring thousands of hours of operation exposed to high temperatures and extreme mechanical loads. Thus, while large tip shrouds are desirable because of the effective manner in which they seal the gas path and the stable connections or interfaces they form between neighboring rotor blades, it will be appreciated that such shrouds are troublesome because of the increased pull loads on the rotor blade, particularly at the base of the airfoil because it must support the entire load of blade. That is to say, to the extent weight may be reduced while still fulfilling structural requirements, the life of the rotor blade may be extended.

As will be appreciated, according to these and other criteria, the design of tip shrouded rotor blades includes many complex, often competing considerations. Novel designs that balance these in a manner that optimizes or enhances one or more desired performance criteria—while still adequately promoting structural robustness, part-life longevity, component manufacturability, and/or cost-effective engine operation—represent economically valuable technology.

### BRIEF DESCRIPTION OF THE INVENTION

The present application thus describes a rotor blade for a gas turbine that includes an airfoil and a tip shroud having a cavitied configuration. The tip shroud may have a seal rail that projects radially from an outboard surface and extends circumferentially. The tip shroud may further include: a rotationally leading circumferential face; a rotationally trailing circumferential face; and an outboard face of the seal rail. The tip shroud may be circumferentially divided into three parallel reference zones that include: a rotationally leading edge zone, a rotationally trailing edge zone and, formed between and separating the rotationally leading edge zone and the rotationally trailing edge zone, a middle zone. The seal rail may include a hollow cavity wholly contained within at least one of the rotationally leading edge zone and the rotationally trailing edge zone. The cavity may include a mouth formed through at least one of the rotationally leading circumferential face, the rotationally trailing circumferential face, and the outboard face of the seal rail.

These and other features of the present application will become apparent upon review of the following detailed description of the preferred embodiments when taken in conjunction with the drawings and the appended claims.

### BRIEF DESCRIPTION OF THE DRAWINGS

These and other features of this invention will be more completely understood and appreciated by careful study of the following more detailed description of exemplary embodiments of the invention taken in conjunction with the accompanying drawings, in which:

FIG. 1 is a schematic representation of an exemplary gas turbine that may include turbine blades according to aspects and embodiments of the present application;

FIG. 2 is a sectional view of the compressor section of the gas turbine of FIG. 1;

FIG. 3 is a sectional view of the turbine section of the gas turbine of FIG. 1;

FIG. 4 is a side view of an exemplary turbine rotor blade according to possible aspects and embodiments of the present application;

FIG. 5 is a section view along sight line 5-5 of FIG. 4;

FIG. 6 is a section view along sight line 6-6 of FIG. 4;

FIG. 7 is a section view along sight line 7-7 of FIG. 4;

FIG. 8 is a perspective view of an exemplary tip shrouded rotor blade according to possible aspects and embodiments of the present application;

FIG. 10 is an outboard profile view of a tip shrouded rotor blades according to possible aspects and embodiments of the present application;

FIG. 11 is a profile view from an outer radial perspective of a tip shroud and seal rail that includes a cavitied configuration according to embodiments of the present application;

FIG. 12 is a perspective view with partial transparency of the tip shroud of FIG. 11;

FIG. 13 is a perspective view with partial transparency of a tip shroud and seal rail that includes an alternative cavitied configuration according to embodiments of the present application;

FIG. 14 is a perspective view with partial transparency of a tip shroud and seal rail that includes an alternative cavitied configuration according to embodiments of the present application;

FIG. 15 is a perspective view with partial transparency of a tip shroud and seal rail that includes an alternative cavitied configuration according to embodiments of the present application; and

FIG. 16 illustrates a method of fabrication according to a possible embodiment of the present application.

### DETAILED DESCRIPTION OF THE INVENTION

Aspects and advantages of the present application are set forth below in the following description, or may be obvious from the description, or may be learned through practice of the invention. Reference will now be made in detail to present embodiments of the invention, one or more examples of which are illustrated in the accompanying drawings. The detailed description uses numerical designations to refer to features in the drawings. Like or similar designations in the drawings and description may be used to refer to like or similar parts of embodiments of the invention. As will be appreciated, each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. It is intended that the present invention covers such modifications and variations as come within the scope of the appended claims and their equivalents. It is to be understood that the ranges and limits mentioned herein include all sub-ranges located within the prescribed limits, inclusive of the limits themselves unless otherwise stated. Additionally, certain terms have been selected to describe the present invention and its component subsystems and parts. To the extent possible, these terms have been chosen based on the terminology common to the technology field. Still, it will be appreciated that such terms often are subject to differing interpretations. For example, what may be referred to herein as a single component, may be referenced elsewhere as consisting of multiple components, or, what may be referenced herein as including multiple components, may be referred to elsewhere as being a single component. In understanding the scope of the present invention, attention should not only be paid to the particular terminology used, but also to the accompanying description and context, as well as the structure, configuration, function, and/or usage of the component being referenced and described, including the manner in which the term relates to the several figures, as well as, of course, the precise usage of the terminology in the appended claims. Further, while the following examples are presented in relation to certain types of gas turbines or turbine engines, the technology of the present application also may be applicable to other categories of turbine engines, without limitation, as would the understood by a person of ordinary skill in the relevant technological arts. Accordingly, it should be understood that, unless otherwise stated, the usage herein of the term “gas turbine” is intended broadly and with limitation as the applicability of the present invention to the various types of turbine engines.

Given the nature of how gas turbines operate, several terms prove particularly useful in describing certain aspects of their function. These terms and their definitions, unless specifically stated otherwise, are as follows. The terms “forward” and “aft” or “aftward” refer to directions relative to the orientation of the gas turbine and, more specifically, the relative positioning of the compressor and turbine sections of the engine. Thus, as used therein, the term “forward” refers to the compressor end while “aft” or “aftward” refers to the turbine end. It will be appreciated that each of these terms may be used to indicate movement or relative position within the engine. The terms “downstream” and “upstream” are used herein to indicate position within a specified conduit relative to the general direction of fluid flowing through it. Thus, the term “downstream” refers to the direction in which the fluid is flowing through the specified conduit, while “upstream” refers to the direction opposite that. These terms may be construed as relating to what would be understood by one skilled in the art as the expected direction of flow through the conduit assuming normal or anticipated operation. Accordingly, for example, the primary flow of working fluid through a gas turbine, which begins as air moving through the compressor and then becomes combustion gases within the combustor for subsequent expansion through the turbine, may be described herein as beginning at a forward or upstream location toward a forward or upstream end of the gas turbine and terminating at an aft or downstream location toward an aft or downstream end of the gas turbine. Finally, as many components of gas turbines rotate during operation, such as compressor and turbine rotor blades, the terms rotationally lead and rotationally trail may be used to delineate included subcomponents or subregions. As will be appreciated, these terms differentiate position relative to a direction of rotation, which may be understood as being an expected direction of rotation given normal operation of the gas turbine.

In addition, given the configuration of the gas turbines, particularly the arrangement of the compressor and turbine sections about a common shaft or rotor, as well as the cylindrical configuration common to many combustor types, terms describing position relative to an axis may be regularly used herein. In this regard, it will be appreciated that the term “radial” refers to movement or position perpendicular to an axis. Related to this, it may be required to describe relative distance from the central axis. In such cases, for example, if a first component resides closer to the central axis than a second component, the first component will be described as being either “radially inward” or “inboard” of the second component. If, on the other hand, the first component resides further from the central axis, the first component will be described as being either “radially outward” or “outboard” of the second component. As used herein, the term “axial” refers to movement or position parallel to an axis, while the term “circumferential” refers to movement or position around an axis. Unless otherwise stated or contextually apparent, these terms describing position relative to an axis should be construed as relating to the central axis of the compressor and turbine sections of the engine as defined by the rotor extending through each. However, the terms also may be used relative to the longitudinal axis of certain components or subsystems within the gas turbine, such as, for example, the longitudinal axis around which conventional cylindrical or “can” combustors are typically arranged.

Finally, the term “rotor blade”, without further specificity, is a reference to the rotating blades of either the compressor or the turbine, and so may include both compressor rotor blades and turbine rotor blades. The term “stator blade”, without further specificity, is a reference to the stationary blades of either the compressor or the turbine and so may include both compressor stator blades and turbine stator blades. The term “blades” may be used to generally refer to either type of blade. Thus, without further specificity, the term “blades” is inclusive to all type of turbine engine blades, including compressor rotor blades, compressor stator blades, turbine rotor blades, turbine stator blades and the like.

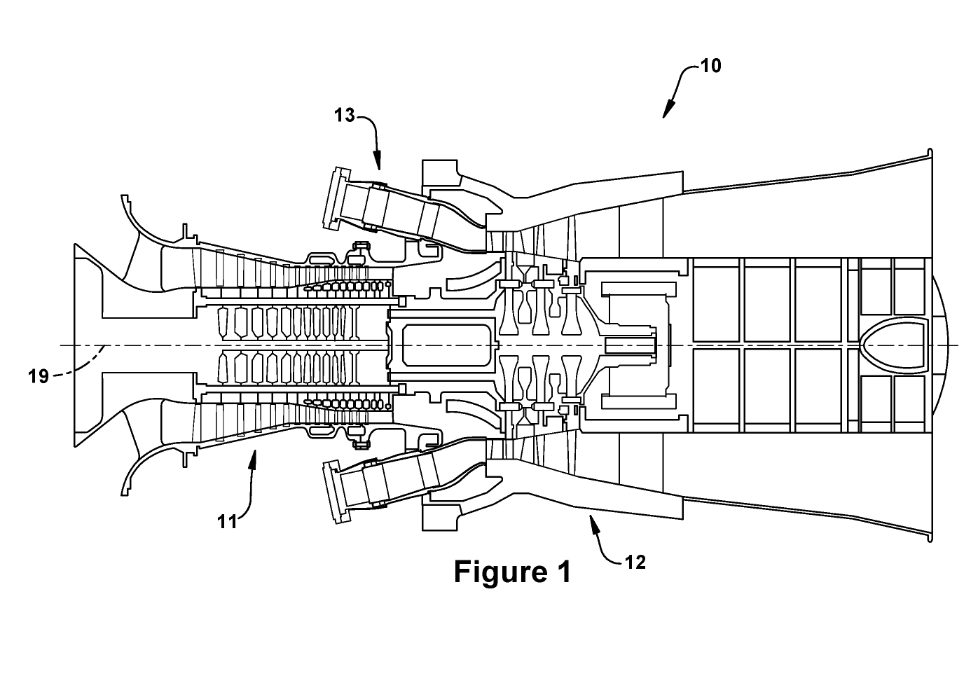

By way of background, referring now to the figures, FIGS. 1 through 3 illustrate an exemplary gas turbine in accordance with the present invention or within which the present invention may be used. It will be understood by those skilled in the art that the present invention may not be limited to this type of usage. As stated, the present invention may be used in gas turbines, such as the engines used in power generation and airplanes, steam turbine engines, as well as other types of rotary engines as would be recognized by one of ordinary skill in the art. The examples provided, thus, are not meant to be limiting unless otherwise stated. FIG. 1 is a schematic representation of a gas turbine 10. In general, gas turbines operate by extracting energy from a pressurized flow of hot gas produced by the combustion of a fuel in a stream of compressed air. As illustrated in FIG. 1, gas turbine 10 may be configured with an axial compressor 11 that is mechanically coupled by a common shaft or rotor to a downstream turbine section or turbine 12, and a combustor 13 positioned between the compressor 11 and the turbine 12. As illustrated in FIG. 1, the gas turbine may be formed about a common central axis 19.

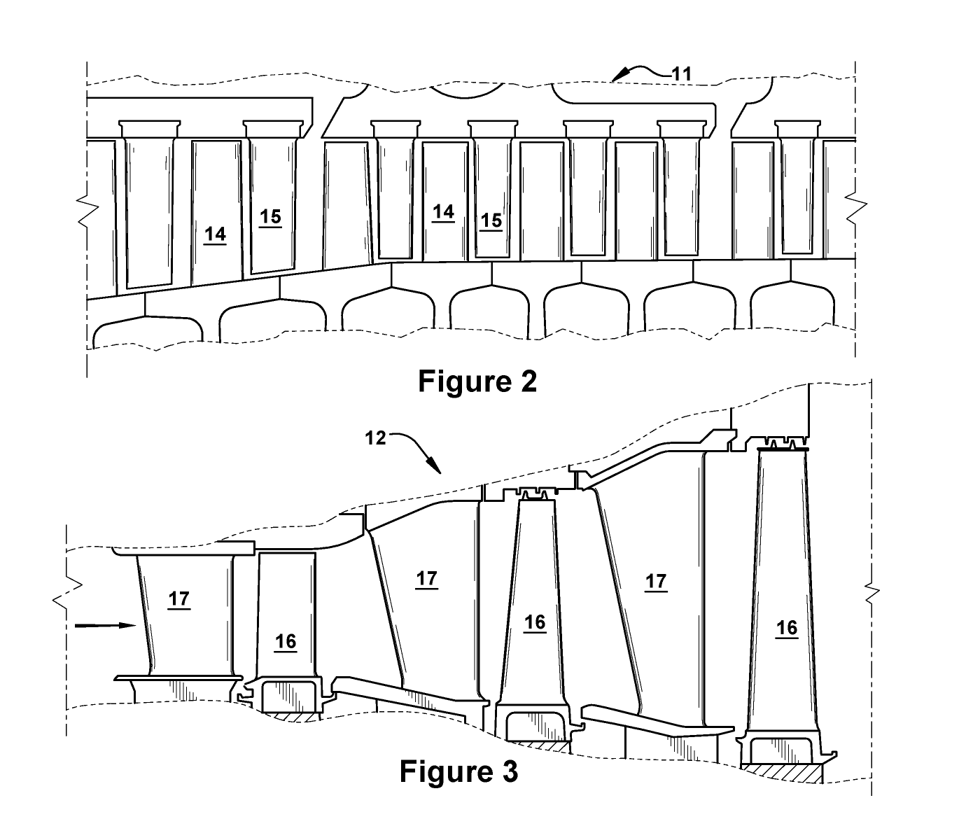

FIG. 2 illustrates a view of an exemplary multi-staged axial compressor 11 that may be used in the gas turbine of FIG. 1. As shown, the compressor 11 may have a plurality of stages, each of which include a row of compressor rotor blades 14 and a row of compressor stator blades 15. Thus, a first stage may include a row of compressor rotor blades 14, which rotate about a central shaft, followed by a row of compressor stator blades 15, which remain stationary during operation. FIG. 3 illustrates a partial view of an exemplary turbine section or turbine 12 that may be used in the gas turbine of FIG. 1. The turbine 12 also may include a plurality of stages. Three exemplary stages are illustrated, but more or less may be present. Each stage may include a plurality of turbine nozzles or stator blades 17, which remain stationary during operation, followed by a plurality of turbine buckets or rotor blades 16, which rotate about the shaft during operation. The turbine stator blades 17 generally are circumferentially spaced one from the other and fixed about the axis of rotation to an outer casing. The turbine rotor blades 16 may be mounted on a turbine wheel or rotor disc (not shown) for rotation about a central axis. It will be appreciated that the turbine stator blades 17 and turbine rotor blades 16 lie in the hot gas path or working fluid flowpath through the turbine 12. The direction of flow of the combustion gases or working fluid within the working fluid flowpath is indicated by the arrow.

In one example of operation for the gas turbine 10, the rotation of compressor rotor blades 14 within the axial compressor 11 may compress a flow of air. In the combustor 13, energy may be released when the compressed air is mixed with a fuel and ignited. The resulting flow of hot gases or working fluid from the combustor 13 is then directed over the turbine rotor blades 16, which induces the rotation of the turbine rotor blades 16 about the shaft. In this way, the energy of the flow of working fluid is transformed into the mechanical energy of the rotating blades and, given the connection between the rotor blades and the shaft, the rotating shaft. The mechanical energy of the shaft may then be used to drive the rotation of the compressor rotor blades 14, such that the necessary supply of compressed air is produced, and also, for example, a generator to produce electricity.

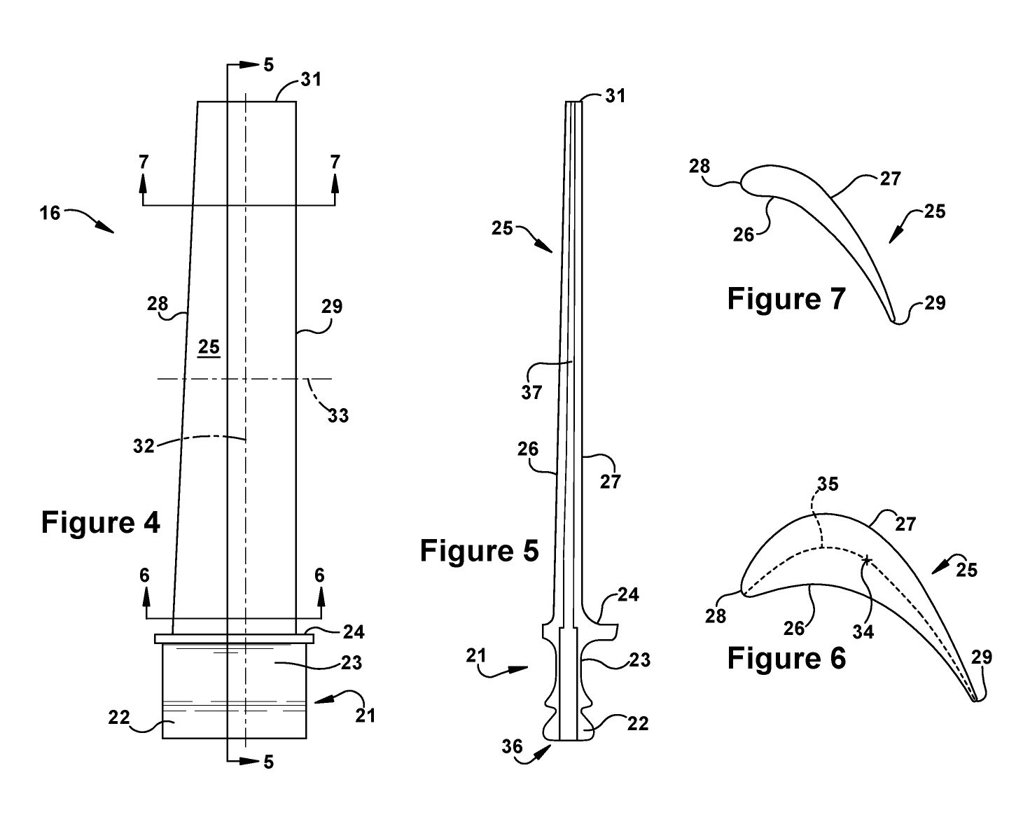

For background purposes, FIGS. 4 through 7 provide views of a turbine rotor blade 16 in accordance with or within which aspects of the present invention may be practiced. As will be appreciated, these figures are provided to illustrate common configurations of rotor blades so to delineate spatial relationships between components and regions within such blades for later reference while also describing geometric constraints and other criteria that affect the internal and external design thereof. While the blade of this example is a rotor blade, it will be appreciated that, unless otherwise stated, the present invention also may be applied to other types of blades within the gas turbine.

The rotor blade 16, as illustrated, may include a root 21 that is used for attaching to a rotor disc. The root 21, for example, may include a dovetail 22 configured for mounting in a corresponding dovetail slot in the perimeter of a rotor disc. The root 21 may further include a shank 23 that extends between the dovetail 22 and a platform 24. The platform 24, as shown, forms the junction of the root 21 and an airfoil 25, which is the active component of the rotor blade 16 that intercepts the flow of working fluid through the turbine 12 and induces rotation. The platform 24 may define the inboard end of the airfoil 25 and a section of the inboard boundary of the working fluid flowpath through the turbine 12.

The airfoil 25 of the rotor blade may include a concave pressure face 26 and a circumferentially or laterally opposite convex suction face 27. The pressure face 26 and suction face 27 may extend axially between opposite leading and trailing edges 28, 29, respectively. The pressure face 26 and suction face 27 also may extend in the radial direction from an inboard end, i.e., the platform 24, to an outboard tip 31 of the airfoil 25. The airfoil 25 may include a curved or contoured shape extending between the platform 24 and the outboard tip 31. As illustrated in FIGS. 4 and 5, the shape of the airfoil 25 may taper gradually as it extends between the platform 24 to the outboard tip 31. The tapering may include an axial tapering that narrows the distance between the leading edge 28 and the trailing edge 29 of the airfoil 25, as illustrated in FIG. 4, as well as a circumferential tapering that reduces the thickness of the airfoil 25 as defined between the suction face 26 and the pressure face 27, as illustrated in FIG. 5. As shown in FIGS. 6 and 7, the contoured shape of the airfoil 25 may further include a twisting about the longitudinal axis of the airfoil 25 as it extends from the platform 24. The twisting typically is configured so to vary a stagger angle for the airfoil 25 gradually between the inboard end and outboard tip 31.

For descriptive purposes, as provided in FIG. 4, the airfoil 25 of the rotor blade 16 may further be described as including a leading edge section or half and trailing edge section or half defined to each side of an axial midline 32. The axial midline 32, according to its usage herein, may be formed by connecting the midpoints 34 of the camber lines 35 of the airfoil 25 between the platform 24 and the outboard tip 31. Additionally, the airfoil 25 may be described as including two radially stacked sections defined inboard and outboard of a radial midline 33 of the airfoil 25. Thus, as used herein, an inboard section or half of the airfoil 25 extends between the platform 24 and the radial midline 33, while an outboard section or half extends between the radial midline 33 and the outboard tip 31. Finally, the airfoil 25 may be described as including a pressure face section or half and a suction face section or half, which, as will be appreciated are defined to each side of the camber line 35 of the airfoil 25 and the corresponding face 26, 27 of the airfoil 25, respectively.

The rotor blade 16 may further include an internal cooling configuration 36 having one or more cooling channels 37 through which a coolant is circulated during operation. The cooling channels 37 may extend radially outward from a connection to a supply source formed through the root 21 of the rotor blade 16. The cooling channels 37 may be linear, curved or a combination thereof, and may include one or more outlet or surface ports through which coolant is exhausted from the rotor blade 16 and into the working fluid flowpath.

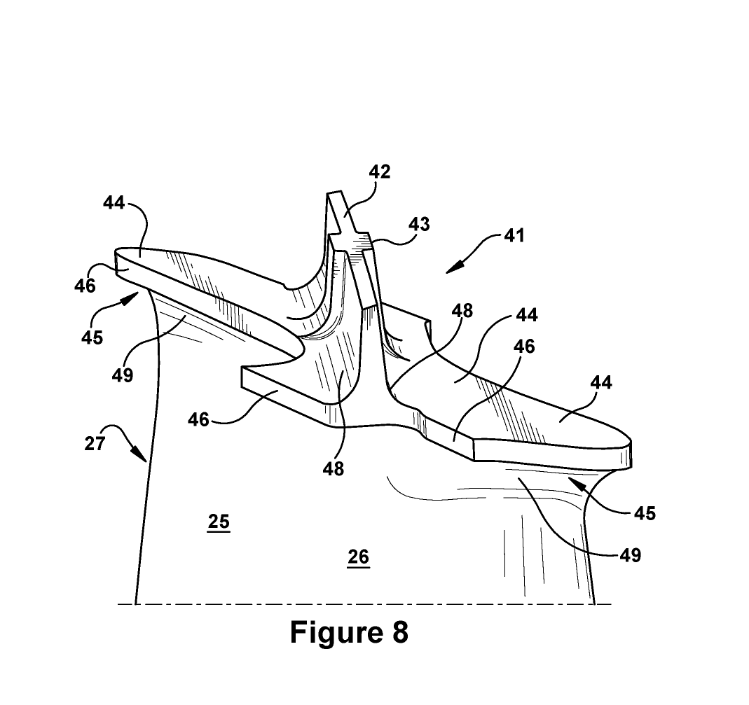

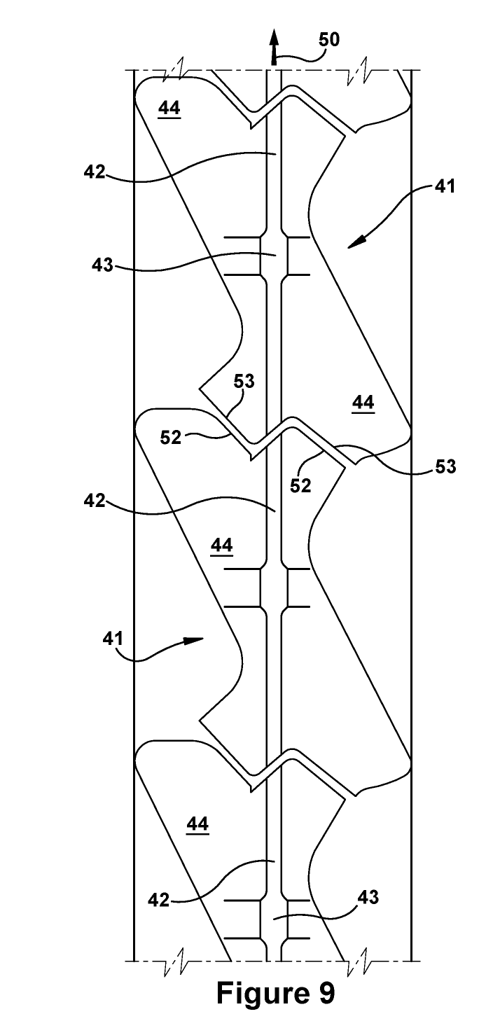

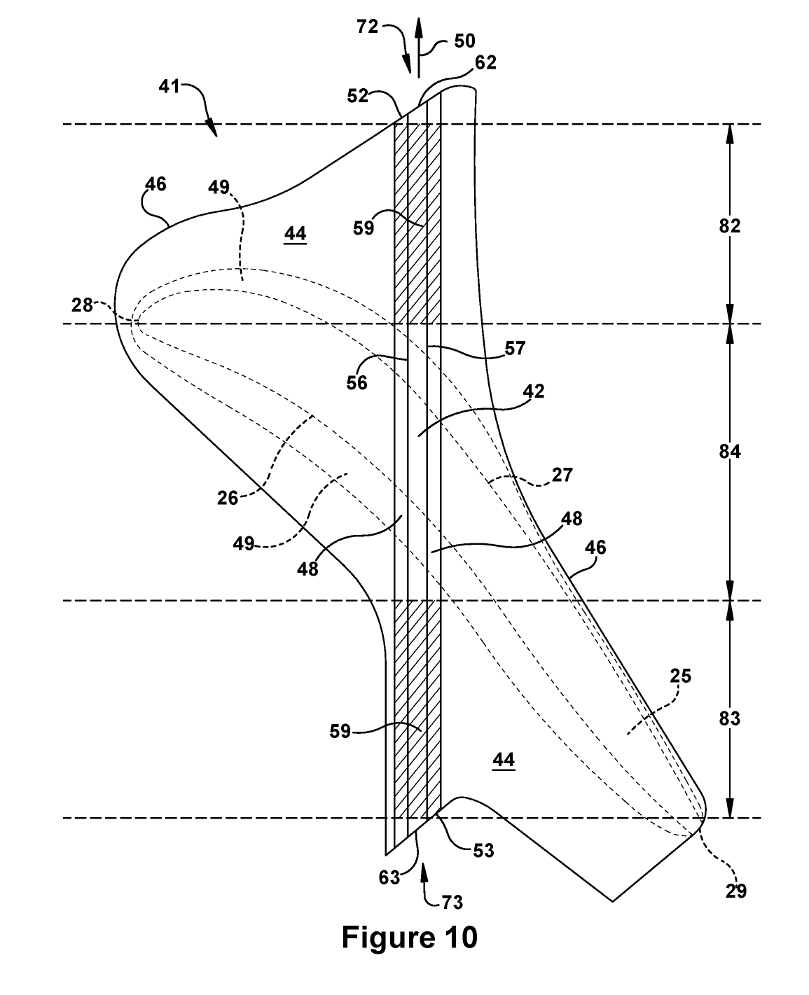

FIGS. 8 through 10 illustrate a turbine rotor blade 16 having a tip shroud 41 in accordance with the present invention or within which the present invention may be used. As will be appreciated, FIG. 8 is a perspective view of an exemplary turbine rotor blade 16 that includes a tip shroud 41. FIG. 9 provides a top view of an exemplary installed arrangement of tip shrouded rotor blades 16. Finally, FIG. 10 provides an enlarged outboard view of a tip shroud 41 that may be used to delineate the different regions within tip shrouds which will be referenced in the discussion to follow.

As shown, the tip shroud 41 may be positioned near or at the outboard end of the airfoil 25. The tip shroud 41 may include an axially and circumferentially extending flat plate or planar component, which is supported towards its center by the airfoil 25. For descriptive purposes, the tip shroud 41 may include an inboard surface 45, outboard surface 44, and edge 46. As illustrated, the inboard surface 45 opposes the outboard surface 44 across the narrow radial thickness of the tip shroud 41, while the edge 46 connects the inboard surface 45 to the outboard surface 44 and, as used herein, defines a peripheral profile or shape of the tip shroud 41.

A seal rail 42 may be positioned along the outboard surface 44 of the tip shroud 41. Generally, as illustrated, the seal rail 42 is a fin-like projection that extends radially outward from the outboard surface 44 of the tip shroud 41. The seal rail 42 may extend circumferentially between opposite ends of the tip shroud 41 in the direction of rotation or “rotation direction” of the rotor blade 16. As will be appreciated, the seal rail 42 may be used to deter leakage of working fluid through the radial gap that exists between the tip shroud 41 and the surrounding stationary components that define the outboard boundary of the working fluid flowpath through the turbine. In some conventional designs, the seal rail 42 may extend radially into an abradable stationary honeycomb shroud that opposes it across that gap. The seal rail 42 may extend across substantially the entire circumferential length of the outboard surface 44 of the tip shroud 41. As used herein, the circumferential length of the tip shroud 41 is the length of the tip shroud 41 in the rotation direction 50. For descriptive purposes, as indicated in FIG. 10, the seal rail 42 may include opposing rail faces, in which a rail forward face 56 corresponds to the forward direction given the orientation of the gas turbine and a rail aftward face 57 corresponds with the aftward direction. As will be appreciated, the rail forward face 56 thus faces toward or into the flow direction of working fluid, while the rail aftward face 57 faces away from it. Each of the rail forward face 56 and rail aftward face 57 may be arranged so to form a steep angle relative to the outboard surface 44 of the tip shroud 41. Though other configurations are possible, the seal rail 42 may have an approximately rectangular profile. The rail forward face 56 and the rail aftward face 57 of the seal rail 42 may connect along circumferentially narrow edges, which, as used herein, include: opposing and approximately parallel outboard and inboard edges, and opposing and approximately parallel rotationally leading and rotationally trailing edges. Specifically, the inboard edge of the seal rail 42 may be defined at the interface between the seal rail 42 and the outboard surface 44 of the tip shroud 41. As will be appreciated, the inboard edge is somewhat obscured given the illustrated fillet regions that are formed between the seal rail 42 and the tip shroud 41, and thus is not specifically referenced by a numeral identifier. The outboard edge 59 of the seal rail 42 is radially offset from the outboard surface 44 of the tip shroud 41. This radial offset, as will be appreciated, generally represents the radial height of the seal rail 42. As indicated, a rotationally leading edge 62 of the seal rail 42 juts radially from the edge 46 of the tip shroud 41 that overhangs the suction face 27 of the airfoil 25. Because of this, the rotationally leading edge 62 is the component that leads the seal rail 42 when the rotor blade 16 is rotated during operation. At the opposite end of the seal rail 42, a rotationally trailing edge 63 juts radially from the edge 46 of the tip shroud 41 that overhangs the pressure face 26 of the airfoil 25. Because of this, the rotationally trailing edge 63 is the component that trails the seal rail 42 when the rotor blade 16 is rotated during operation.

A cutter tooth 43 may be disposed on the seal rail 42. As will be appreciated, the cutter tooth 43 may be provided for cutting a groove in the abradable coating or honeycomb of the stationary shroud that is slightly wider than the width of the seal rail 42. As will be appreciated, the honeycomb may be provided to enhance seal stability, and the use of the cutter tooth 43 may reduce spillover and rubbing between stationary and rotating parts by clearing this wider path.

The tip shroud 41 may include fillet regions 48, 49 that are configured to provide smooth surficial transitions between the divergent surfaces of the tip shroud 41 and the airfoil 25, as well as those between the tip shroud 41 and the seal rail 42. As such, configurations of the tip shroud 41 may include an inboard fillet region 49 that is formed between the inboard surface 45 of the tip shroud 41 and the pressure and suction faces 26, 27 of the airfoil 25. The tip shroud 41 also may include an outboard fillet region 48 that is formed between the outboard surface 44 of the tip shroud 41 and the rail forward face 56 and aftward face 57 of the seal rail 42. As will be appreciated, the inboard fillet region 49 may further be described as including: a pressure inboard fillet region between the pressure face 26 of the airfoil 25 and the inboard surface 45 of the tip shroud 41; and a suction inboard fillet region between the suction face 26 of the airfoil 25 and the inboard surface 45 of the tip shroud 41. Similarly, the outboard fillet region 48 may be described as including: a pressure outboard fillet region between the rail forward face 56 and the outboard surface 44 of the tip shroud 41; and a suction outboard fillet region between the rail aftward face 57 and the outboard surface 44 of the tip shroud 41. As depicted, each of these fillet regions 48, 49 may be configured to provide smoothly curving transitions between the several planar surfaces that form abrupt or steeply angle transitions. As will be appreciated, such fillet regions may improve aerodynamic performance as well as spread stress concentrations that would otherwise occur in those areas. Even so, these areas remain highly stressed due to the overhanging or cantilevered load of the tip shroud 41 and the rotational speed of the engine. As will be appreciated, without adequate cooling, the stresses in these areas are a significant limit on the useful life of the component.

With particular reference now to FIG. 9, tip shrouds 41 may be configured to include a contact interface in which contact surfaces or edges engage like surfaces or edges formed on the tip shrouds 41 of neighboring rotor blades during operation. As will be appreciated, this may be done, for example, to reduce leakage or harmful vibration. FIG. 9 provides an outboard view of tip shrouds 41 on turbine rotor blades as they might appear in an assembled condition. As indicated, relative to the rotation direction 50, the edge 46 of the tip shroud 41, for descriptive purposes, may include a rotationally leading contact edge 52 and a rotationally trailing contact edge 53. Thus, as shown, the tip shroud 41 in a rotationally leading position may be configured with a rotationally trailing contact edge 53 that contacts or comes in close proximity to the rotationally leading contact edge 52 of the tip shroud 41 in a rotationally trailing position relative to it. This area of contact between the neighboring tips shrouds 41 may be generally referred to as a contact interface. Given the profile of the exemplary configuration, the contact interface may be referred to as a “Z-notch” interface, though other configurations are also possible. More generally, in forming the contact interface, the edge 46 of the tip shroud 41 may be configured with a notched section that is intended to contact or engage a neighboring tip shroud 41 in a predetermined manner.

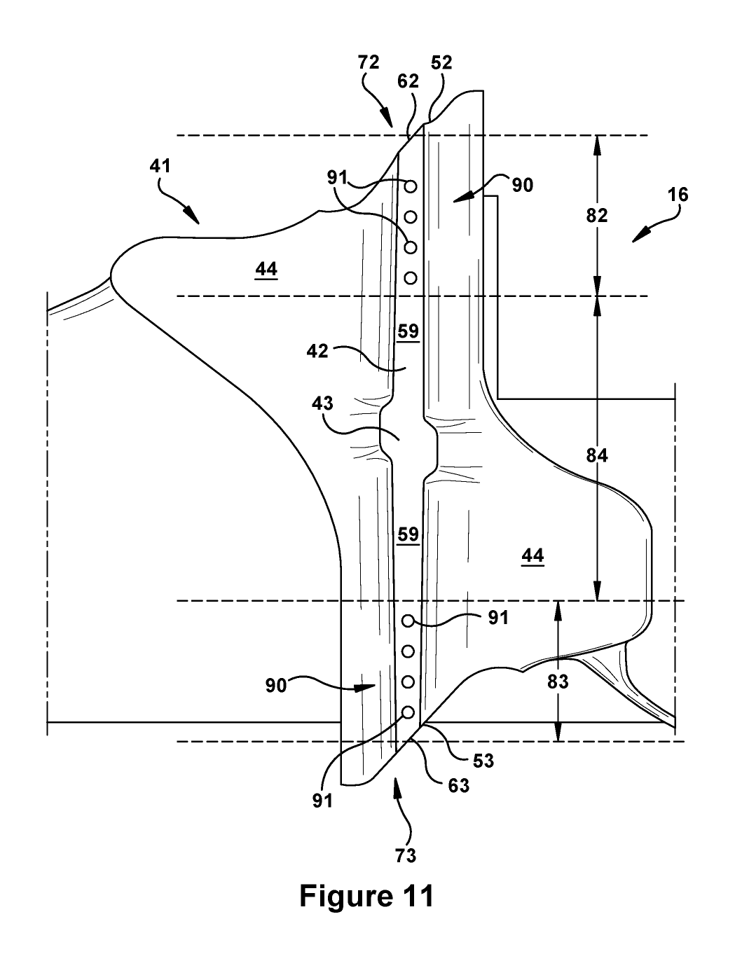

With particular reference now to FIG. 10, the profile of the tip shroud 41 may have a scallop shape, though other configurations are also possible. As will be appreciated, the exemplary scallop shape is one that performs well in terms of reducing leakage while reducing weight of the tip shroud. Whatever the profile, it will be appreciated that the regions or subregions associated with the outboard tip 31 and tip shroud 41 may be described given their position relative to the seal rail 42 and/or the profile of the underlying airfoil 25 and/or the fillet regions 48, 49 associated therewith. These areas and other components of the tip shroud 41 will now be discussed for further reference below in relation to FIGS. 11 through 16.

The tip shroud 41 may be described as including circumferential faces that, relative the rotation direction, may be designated as a rotationally leading circumferential face 72 and a rotationally trailing circumferential face 73. As used herein, the rotationally leading circumferential face 72 includes the rotationally leading edge 52 of tip shroud 41 and the rotationally leading edge 62 of seal rail 42. The rotationally trailing circumferential face 73 includes the rotationally trailing edge 53 of tip shroud 41 and the rotationally trailing edge 63 of seal rail 42. Further, an outboard face 59 of the seal rail 42 may be defined along the outer radial edge or face of the seal rail 42 that faces in the outboard direction. (Note that this component was previously referenced herein as the outboard edge 59 of the seal rail 42. Either term may be used interchangeably.) As illustrated in FIG. 10, the tip shroud 41 and the seal rail 42 included thereon may be circumferentially divided into three parallel reference zones. These may include a rotationally leading edge zone 82, a rotationally trailing edge zone 83, and, formed between and separating the rotationally leading edge zone 82 from the rotationally trailing edge zone 83, a middle zone 84. As indicated, the rotationally leading edge zone 82 is defined between the middle zone 84 and the rotationally leading circumferential face 72, while the rotationally trailing edge zone 83 is defined between the middle zone 84 and the rotationally trailing circumferential face 73. As will be understood, the positioning of the boundaries between these zones and the zones themselves will be used below to more clearly describe certain embodiments of the present invention.

With reference now to FIGS. 11 through 16, several tip shroud configurations and a method of manufacture related thereto are presented which are in accordance with exemplary embodiments of the present invention. As will be appreciated, these examples are described with reference to and in light of the systems and related concepts provided above, particularly those discussed in relation to the preceding figures.

The present invention may include tip shrouds having a configuration in which hollow cavities, pockets, chambers, voids and the like (which collectively will referred to herein as cavities) are formed to reduce tip shroud mass while also maintaining structural performance and robustness. These cavities may be enclosed via preformed coverplates that are brazed or welded into place. Alternatively, the coverplates may be applied by laser cladding, laser deposition, or other additive manufacturing processes. According to exemplary embodiments, such cavities may be strategically positioned so to reduce stresses applied to the tip shroud fillet regions and/or contact faces without also reducing the overall stiffness and structural performance in the affected regions. As described below, such cavities may be formed via conventional machining processes, including electro-chemical, chemical or mechanical processes. In alternative embodiments, the cavities may be formed during conventional blade casting processes for additive manufacturing processes. According to certain preferred embodiments, the cavities may be formed through one of several identified tip shroud surfaces, which are described below, and the cavities may be substantially or wholly contained within certain prescribed internal target regions associated with the seal rail. In this manner, the present invention may enable the removal of dead mass from particular internal regions of the tip shroud and/or seal rail so to reduce weight while maintaining overall structural resilience. As will be shown, present configurations may reduce the overall weight of the rotor blade without reducing or compromising other areas that are more structurally critical, such as those within the fillet regions or structurally active internal areas of the airfoil. The hollowed or cavitied portions may be optimally limited to target areas, which are readily identifiable based on the relative positioning and configuration of the tip shroud and seal rail. The present invention may optimize the location of the cavitied portions by delineating those internal regions that bear minimal bending load. In this manner, bending stiffness and overall structural robustness may be maintained, while mass is removed and, thus, operational stresses reduced.

As will be appreciated, such mass reduction may enable significant performance benefits. The weight reduction, for example, may simply reduce overall pull forces acting on the rotor blade during operation, and, thereby, extend creep life at life-limiting locations on the airfoil. Analysis of present configurations show creep life improvements to critical areas, such as fillet regions, by 5% to 20%. Alternatively, the weight reduction enabled by the present invention may be used to increase the overall size of the tip shroud without increasing overall weight. This, for example, may enable increasing the size of the contact faces of the tip shroud, which may reduce stress concentrations that occur when the tip shrouds of neighboring rotor blades engage during engine operation. Other examples include the possible reduction of fillet sizes or increase in tip shroud coverage, which may boost aerodynamic performance without increasing stress levels. Additionally, as provided below, the present invention includes efficient methods by which such enhanced tip shrouds may be constructed. That is to say, many of the present configurations may be cost-effectively constructed per the processes described herein. Additionally, the post-cast manufacturability of the exemplary methods allow for the efficient retrofitting of existing rotor blades, which may be used to extend component life.

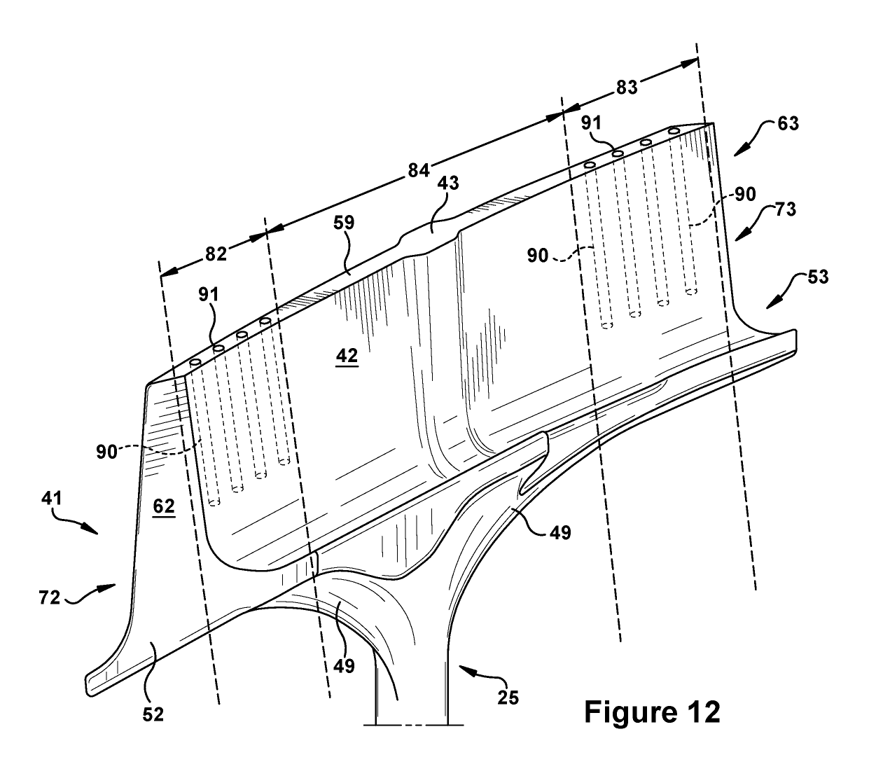

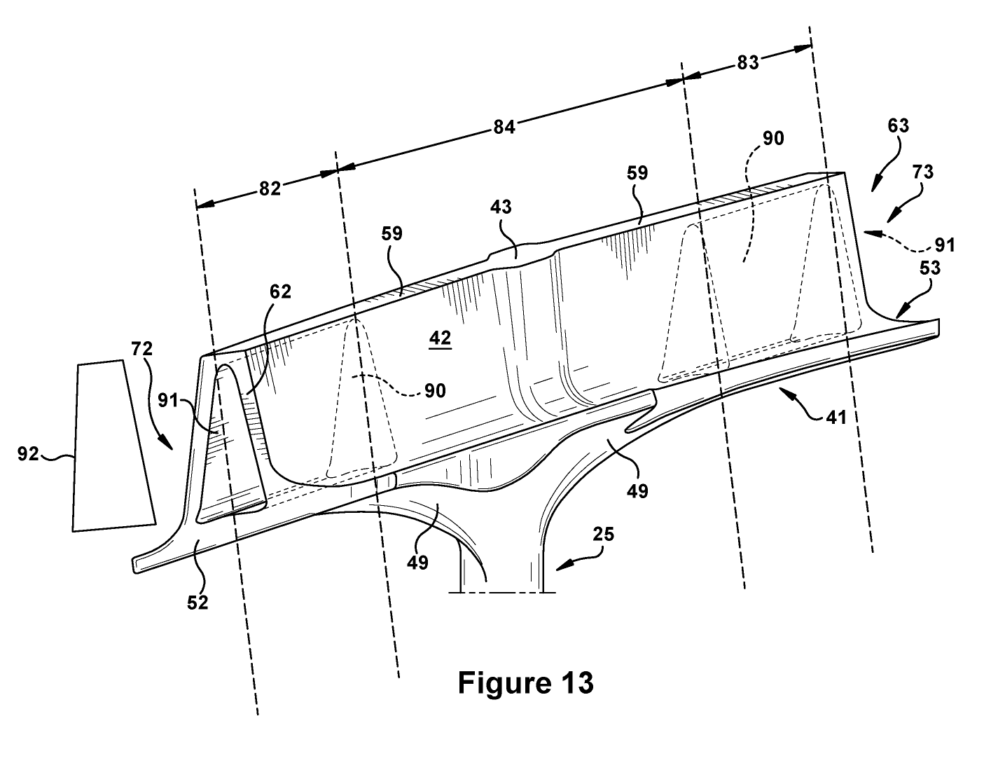

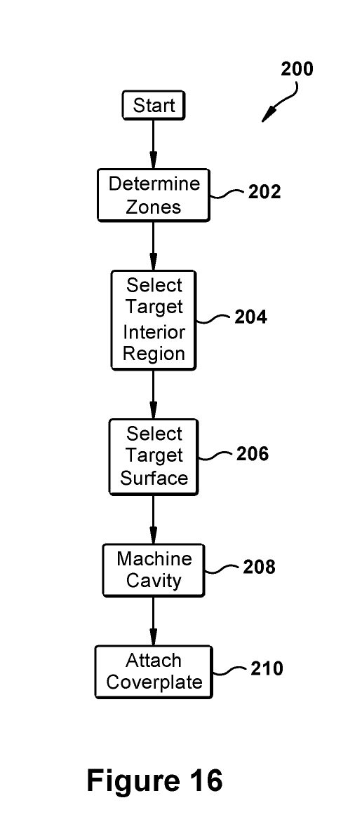

Referring specifically now to FIGS. 11 through 15, the present invention may include a cavitied configuration in which one or more cavities 90 are formed within the seal rail 42 portion of the tip shroud 41. According to present configurations, the cavities 90 may be formed and wholly or substantially contained within the rotationally leading edge zone 82 and/or the rotationally trailing edge zone 83, which are the reference regions introduced above for describing certain regions the tip shroud 41 and/or seal rail 42. As described more below, such cavities 90 may include a mouth 91 formed through the leading circumferential face 72; the rotationally trailing circumferential face 73; and/or the outboard edge or outboard face 59 of the seal rail 42. Further, according to alternative embodiments, the tip shroud 41 may be configured such that the cavities 90 are segregated from any of the cooling channels that may be formed within the rotor blade 16. In such cases, the tip shroud 41 may include structure that prevents or blocks any connection between the cavities 90 and any internal cooling passages that may be formed within the rotor blade 16. As will be seen, FIGS. 11 and 12 are views of a cavitied configuration having radially oriented or aligned cavities 90 in accordance with exemplary embodiments, while FIGS. 13 through 15 depict configurations having circumferentially aligned cavities 90. Finally, FIG. 16 illustrates a method of fabrication according to the present application.

As will be appreciated, the edge zones 82, 83 may be used herein to define a range in which the cavities 90 of the present invention may be located. As stated, the cavities 90 may be defined has being wholly or substantially contained within one of the edge zones 82, 83, which, as used herein, means that the cavity 90 does not extend beyond or substantially beyond the edge zone and into the middle zone 84. As shown in FIG. 10, each of the edge zones 82, 83 are defined between a corresponding one of the circumferential faces 72, 73 and the middle zone 84. Thus, defining the circumferential range of the middle zone 84 may define each of the edge zones 82, 83 and, consequently, the extent to which the positioning of the cavities 90 may encroach toward the center or middle region of the seal rail 42 (which, as illustrated, is the area of the seal rail 42 approximately surrounding the cutter tooth 43). As will be appreciated and per the definitions provided herein, the middle zone 84 represents a highly stressed region within the seal rail 42 within which placement of a cavity 90 may be inadvisable or, at least, not preferable. According to the exemplary embodiments, the middle zone 84 may be defined so to include therewithin the portion of the seal rail 42 that resides over (i.e., not cantilevered outwardly from) the inboard structure that supports the tip shroud 41 and seal rail 42. As will be understood, this means that the edge zones 82, 83 coincide approximately to those regions of the seal rail 42 that are cantilevered relative to the inboard structure supporting the tip shroud 41. Thus, generally, and in accordance with the exemplary embodiments of the present invention, the middle zone 84 may be defined so to include therewithin the segment of the seal rail 42 that overlaps with the profile of the airfoil 25 and/or the inboard fillet region 49 associated therewith. More specifically, pursuant to certain exemplary embodiments, the circumferential range of the middle zone 84 may be defined via the profile of the underlying airfoil 25. In such cases, the circumferential range of the middle zone 84 may correspond to the circumferential range of the outboard tip 31 of the airfoil 25, where the circumferential range of the outboard tip 31 of the airfoil 25 is defined between a rotationally leading edge and rotationally trailing edge. According to another definition in accordance with the present invention, the circumferential range of the middle zone 84 is defined via the profile of the underlying inboard fillet region 49. As already described, the inboard fillet region 49 may be a narrow radial section of the airfoil that forms a smooth transition between the airfoil 25 and the inboard surface 45 of the tip shroud 41. The circumferential range of the middle zone 84 may correspond to the circumferential range of the inboard fillet region 49, which, as illustrated, may be defined between a rotationally leading edge and a rotationally trailing edge of the inboard fillet region 49.

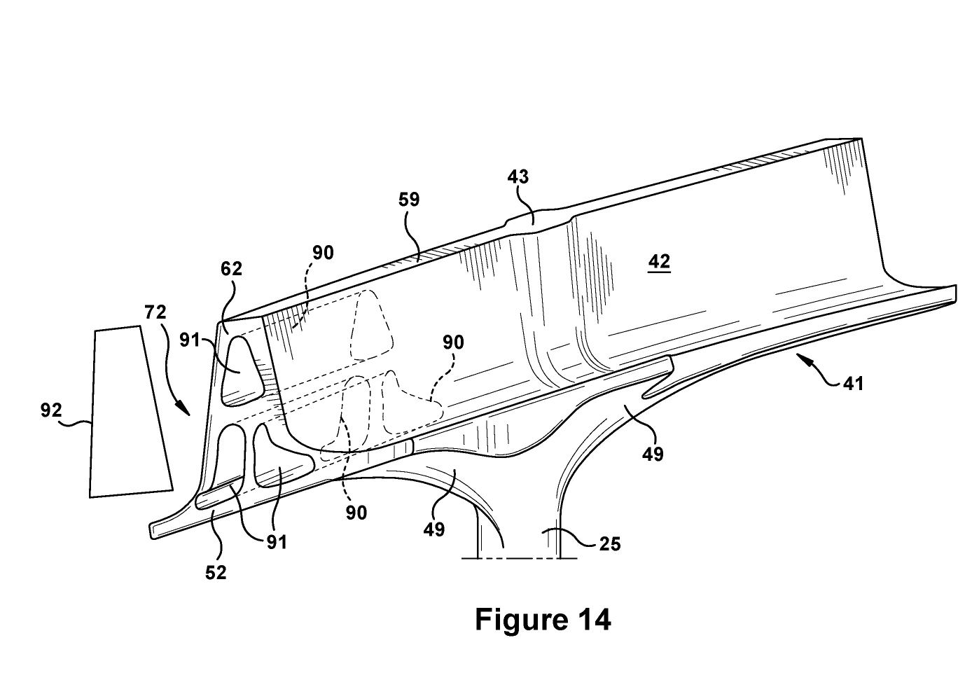

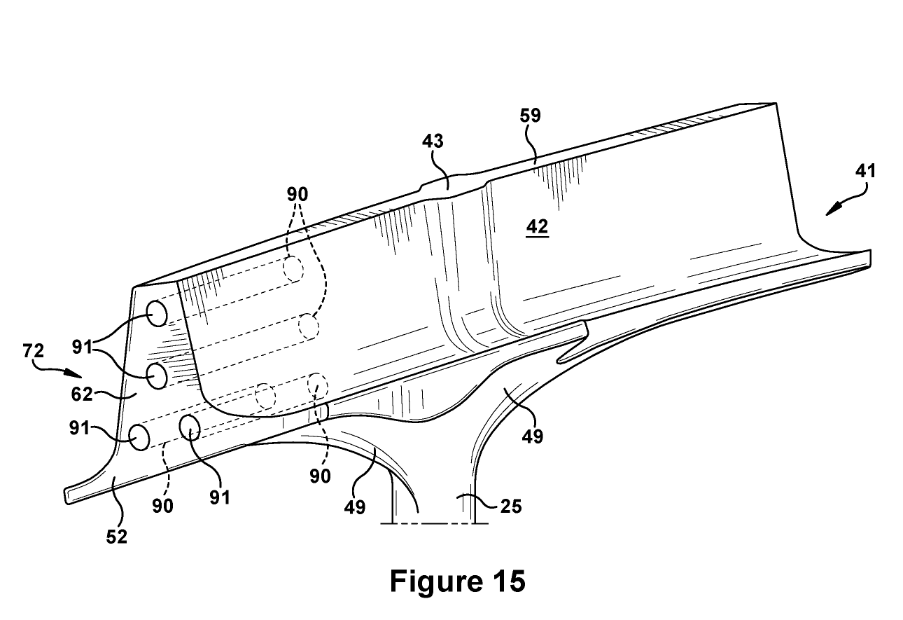

Further, according to preferred embodiments, as shown in FIGS. 11 through 13, one or more of the cavities 90 of the present invention may be formed in each of the rotationally leading edge zone 82 and the rotationally trailing edge zone 83. According to other possible configurations, such as those shown in FIGS. 14 and 15, one or more of the cavities 90 are formed in just one of the rotationally leading edge zone 82 and the rotationally trailing edge zone 83.

Additionally, the cavities 90 may be radially or circumferentially aligned. More specifically, FIGS. 11 and 12 illustrated exemplary radially aligned cavities 90, which are shown formed through the outboard face 59 of the seal rail 42 within both of the edge zones 82, 83. As depicted, radially aligned cavities 90 may extend in an inboard direction from a mouth 91 formed through the outboard face 59 of the seal rail 42. As illustrated, the mouths 91 of the radially aligned cavities 90 may include a regular circumferential spacing on the outboard face 59 of the seal rail 42. While the cavities 90 may be cylindrical in shape, as shown in FIGS. 12 and 13, other configurations, such as but not limited to, elliptical, oval, square, rectangular, triangular, polygon, or other curvilinear shapes, are contemplated. The cross-sectional area of cavities 90 may be constant or varied along the length of the cavity. For example, the radially inboard end of the cavity 90 may have a larger or smaller cross-sectional area than the mouth 91. Alternatively, FIGS. 13 through 15 illustrate exemplary circumferentially aligned cavities 90, which, as shown, are ones that extend along a circumferentially aligned path from mouths formed through the corresponding circumferential face 72, 73. In such cases, the cavities 90 and mouths 91 may include several different cross-sectional shapes, including the circular and triangular ones that are shown. Cavity configurations such as trapezoidal, elliptical, square, rectangular, polygon, or other curvilinear shapes are also contemplated. The cross-sectional area of cavities 90 may be constant or varied along the length of the cavity. For example, the portion of the cavity 90 nearer the middle zone 84 may have a larger or smaller cross-sectional area than the mouth 91. As indicated in FIGS. 13 and 14, the circumferential faces 72, 73 may include a non-integral coverplate 92 that is affixed thereto for enclosing the one or more mouths 91 of the cavities 90 that are formed therethrough.

With specific reference now to FIG. 16, the present invention may include efficient manufacturing methods for constructing tip shrouded rotor blades. Among other novel aspects, the present invention describes the use of straightforward and cost-effective machining processes for significantly improving the performance of such rotor blades, which may be employed in both new rotor blade and retrofit applications. As illustrated, an exemplary method 200 may generally include the steps of: determining the applicable zones 82, 83, 84 for the tip shroud 41 (step 202); selecting a target internal region within at least one of the edge zones 82, 83 for forming one or more of the cavities 90, which selection may be made pursuant to a minimal bending load criteria with the edge zones 82, 83 (step 204); selecting a corresponding target surface through which to form the cavity 90 given the selected target internal region, wherein the target surface comprises at least one of the rotationally leading circumferential face 72, the rotationally trailing circumferential face 73, and an outboard face 59 of the seal rail 41 (step 206); and, finally, forming the cavity 90 via a machining process through the target surface (step 208). The cavities 90 may also be formed in the selected target internal regions during the blade casting process and/or during additive manufacturing processes. Alternatively, the method 200 may also include the step of affixing a coverplate 92 to the target surface to enclose the cavity 90 formed therethrough. As will be understood, further steps will be apparent to one of ordinary skill in the art given the material disclosed above, particularly that material related to the FIGS. 11 through 15, as may be included in the appended claims.

As one of ordinary skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, all of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

That which is claimed:

1. A rotor blade for a gas turbine that includes:
an airfoil defined between a concave pressure face and a laterally opposed convex suction face, wherein the pressure face and the suction face extend axially between opposite leading and trailing edges and radially between an outboard tip and an inboard end that attaches to a root configured for coupling the rotor blade to a rotor disc;
a tip shroud supported at the outboard tip of the airfoil and defined between opposing inboard and outboard surfaces, the tip shroud having a seal rail projecting radially from the outboard surface and extending circumferentially in a rotation direction of the rotor blade, wherein the tip shroud further comprises:
a rotationally leading circumferential face;
a rotationally trailing circumferential face; and
an outboard face of the seal rail;
wherein the tip shroud is circumferentially divided into three parallel reference zones that include: a rotationally leading edge zone, a rotationally trailing edge zone and, formed between and separating the rotationally leading edge zone and the rotationally trailing edge zone, a middle zone;
wherein:
the rotationally leading edge zone is defined between the middle zone and the rotationally leading circumferential face; and
the rotationally trailing edge zone is defined between the middle zone and the rotationally trailing circumferential face;
wherein:
the seal rail comprises a cavity contained substantially within at least one of: the rotationally leading edge zone; and the rotationally trailing edge zone; and
wherein the cavity comprises a mouth formed through at least one of: the rotationally leading circumferential face; the rotationally trailing circumferential face; and the outboard face of the seal rail.

2. The rotor blade according to claim 1, wherein, assuming proper installation therein, the rotor blade is describable according to orientation characteristics of the gas turbine; and
wherein the orientation characteristics of the gas turbine include:
relative radial, axial, and circumferential positioning defined pursuant to a central axis of the gas turbine that extends through a compressor and a turbine;
a forward direction and an aftward direction defined relative to a forward end of the gas turbine comprising the compressor and an aftward end of the gas turbine comprising the turbine;
a flow direction defined relative to an expected direction of flow of a working fluid through a working fluid flowpath defined through the compressor and the turbine, the flow direction comprising a reference line that is parallel to the central axis of the gas turbine and aimed in the aftward direction; and
a rotation direction defined relative to an expected direction of rotation of the rotor disc during operation of the gas turbine; and
wherein the cavity comprises a hollow cavity that is wholly contained within the at least one of the rotationally leading edge zone and the rotationally trailing edge zone.

3. The rotor blade according to claim 2, wherein the tip shroud comprises an axially and circumferentially extending planar component having a narrow radial thickness; and
wherein:
the rotationally leading circumferential face comprises rotationally leading edges of the tip shroud and the seal rail that face toward the rotation direction;
the rotationally trailing circumferential face comprises rotationally trailing edges of the tip shroud and the seal rail that face opposite of the rotation direction; and
the outboard face of the seal rail is defined as an outboard edge of the seal rail that faces in an outboard direction.

4. The rotor blade according to claim 3, wherein the outboard tip of the airfoil comprises a circumferential range defined between a rotationally leading edge and a rotationally trailing edge; and
wherein a circumferential range of the middle zone coincides with the circumferential range of the outboard tip of the airfoil.

5. The rotor blade according to claim 3, wherein the airfoil includes an inboard fillet region, the inboard fillet region comprising a radial section just inboard of the tip shroud in which a cross-sectional profile of the airfoil gradually enlarges so to transition between surfaces of the airfoil and the inboard surface of the tip shroud;
wherein the inboard fillet region comprises a circumferential range between a rotationally leading edge and a rotationally trailing edge; and
wherein a circumferential range of the middle zone coincides with the circumferential range of the inboard fillet region.

6. The rotor blade according to claim 3, wherein the airfoil includes an inboard fillet region, the inboard fillet region comprising a radial section just inboard of the tip shroud in which a cross-sectional profile of the airfoil gradually enlarges so to transition between surfaces of the airfoil and the inboard surface of the tip shroud; and
wherein the circumferential range of the middle zone is configured such that a portion of the seal rail overhanging the inboard fillet region resides therein.

7. The rotor blade according to claim 3, wherein the middle zone is configured so to include therein a portion of the seal rail that overlaps circumferentially with an inboard fillet region formed between the airfoil and the tip shroud; and
wherein the inboard fillet region comprises a curved concave surface configured for smoothly transitioning between surfaces of the airfoil and the inboard surface of the tip shroud.

8. The rotor blade according to claim 7, wherein each of the rotationally leading circumferential face and the rotationally trailing circumferential face comprises a contact face; and
wherein the rotor blade is configured such that the contact faces of the rotationally leading circumferential face and the rotationally trailing circumferential face cooperatively engage across an interface when properly installed within a row of samely configured rotor blades.

9. The rotor blade according to claim 8, wherein the seal rail comprises opposing rail faces, in which:
a forward face of the seal rail corresponds to a forward direction in the gas turbine; and
an aftward face of the seal rail corresponds to an aftward direction in the gas turbine.
wherein each of the rotationally leading edge, the rotationally trailing edge, and the outboard face of the seal rail spans between and are approximately normal to the forward face and the aftward face of the seal rail;
wherein the seal rail extends across substantially an entire circumferential length of the outboard surface of the tip shroud; and
wherein the outboard face of the seal rail is offset from the outboard surface of the tip shroud by a radial height of the seal rail that is substantially constant.

10. The rotor blade according to claim 9, the seal rail comprises the cavity wholly contained within each of: the rotationally leading edge zone; and the rotationally trailing edge zone;
wherein the rotor blade comprises a turbine rotor blade configured for use in the turbine; and
wherein the tip shroud comprises solid structure blocking any connection of either of the cavities to any cooling passage formed within the rotor blade, the coolant passage comprising any internal passage of the rotor blade through which a coolant is circulated during operation.

11. The rotor blade according to claim 10, wherein:
the cavity formed within the rotationally leading edge zone is circumferentially aligned such that the mouth is formed through the rotationally leading circumferential face; and
the cavity formed within the rotationally trailing edge zone is circumferentially aligned such that the mouth is formed through the rotationally trailing circumferential face.

12. The rotor blade according to claim 10, wherein the seal rail comprises multiple ones of the cavity wholly contained within each of: the rotationally leading edge zone; and the rotationally trailing edge zone; and
wherein:
the cavities formed within the rotationally leading edge zone are circumferentially aligned such that the mouth of each is formed through the rotationally leading circumferential face; and
the cavities formed within the rotationally trailing edge zone are circumferentially aligned such that the mouth of each is formed through the rotationally trailing circumferential face.

13. The rotor blade according to claim 12, wherein:
the rotationally leading circumferential face includes a non-integral coverplate affixed thereto for enclosing the mouths of the cavities formed therethrough; and
the rotationally trailing circumferential face includes a non-integral coverplate affixed thereto for enclosing the mouths of the cavities formed therethrough.

14. The rotor blade according to claim 10, wherein:
the cavity formed wholly within the rotationally leading edge zone is radially aligned such that the mouth is formed through the outboard face of the seal rail; and
the cavity formed wholly within the rotationally trailing edge zone is radially aligned such that the mouth is formed through the outboard face of the seal rail.

15. The rotor blade according to claim 14, wherein the seal rail comprises multiple ones of the cavity wholly contained within each of: the rotationally leading edge zone; and the rotationally trailing edge zone; and
wherein:
the cavities formed wholly within the rotationally leading edge zone are radially aligned such that the mouth of each is formed through the outboard face of the seal rail; and
the cavities formed wholly within the rotationally trailing edge zone are radially aligned such that the mouth of each is formed through the outboard face of the seal rail.

16. The rotor blade according to claim 15, wherein:
the mouths of the cavities of the rotationally leading edge zone comprise a regular circumferential spacing; and
the mouths of the cavities of the rotationally trailing edge zone comprise a regular circumferential spacing.

17. A method of manufacturing a rotor blade for use in a turbine of a gas turbine, wherein the rotor blade includes:
an airfoil defined between a concave pressure face and a laterally opposed convex suction face, wherein the pressure face and the suction face extend axially between opposite leading and trailing edges and radially between an outboard tip and an inboard end that attaches to a root configured for coupling the rotor blade to a rotor disc;
a tip shroud comprising an axially and circumferentially extending planar component having a narrow radial thickness defined between opposing inboard and outboard surfaces, the tip shroud having a seal rail projecting radially from the outboard surface and extending circumferentially in a rotation direction of the rotor blade, wherein the tip shroud further comprises:
a rotationally leading circumferential face;
a rotationally trailing circumferential face; and
an outboard face of the seal rail;
wherein the tip shroud is circumferentially divided into three parallel reference zones that include: a rotationally leading edge zone, a rotationally trailing edge zone and, formed between and separating the rotationally leading edge zone and the rotationally trailing edge zone, a middle zone; and
wherein:
the rotationally leading edge zone is defined between the middle zone and the rotationally leading circumferential face; and
the rotationally trailing edge zone is defined between the middle zone and the rotationally trailing circumferential face;
the method including the steps of:
selecting a target internal region wholly contained within one of: the rotationally leading edge zone; and the rotationally trailing edge zone;
selecting a target surface on one of: the rotationally leading circumferential face; the rotationally trailing circumferential face; and the outboard face of the seal rail; and
forming a cavity in the target internal region through the target surface.

18. The method according to claim 17, wherein the target internal region is selected pursuant to a minimal bending load criteria; and
wherein the step of forming the cavity comprises hollowing out the target internal region via a machining process through the target surface.

19. The method according to claim 18, further comprising the step of affixing a coverplate to the target surface so to enclose the cavity.

20. The method according to claim 19, wherein the middle zone is configured so to include therein a portion of the seal rail that overlaps circumferentially with an inboard fillet region formed between the airfoil and the tip shroud; and
wherein the inboard fillet region comprises a curved concave surface configured for smoothly transitioning between surfaces of the airfoil and the inboard surface of the tip shroud.
